(19) United States
(12) Patent Application Publication
(10) Pub. No.: US 2009/0274331 A1
(43) Pub. Date: Nov. 5, 2009

(54) MICROPHONE DEVICE ADAPTED TO BE WORN ON AN EAR

(75) Inventor: Chih-Hung Weng, Chiayi County (TW)

Correspondence Address: MICHAEL W. TAYLOR, P.O. BOX 3791, ORLANDO, FL, 32802-3791, US

(73) Assignee: Mipro Electronics Co., Ltd., Chiayi (TW)

(21) Appl. No.: 12/114,251

(22) Filed: May 2, 2008

(51) Int. Cl. H04R 11/04

(52) U.S. Cl. 381/364

(57) ABSTRACT

A microphone device includes an earpiece unit and a sound pickup unit. The earpiece unit includes a pliable ring part adapted for looping around an ear of a wearer and bendable to conform to the shape of the ear of the wearer. The sound pickup unit includes a boom component that is connected to the earpiece unit and that has a front boom section extending to a vicinity of the mouth of the wearer when the earpiece unit is worn on the ear of the wearer. The sound pickup unit further includes a sound pickup member mounted on the front boom section of the boom component.

### BACKGROUND OF THE INVENTION

1. Field of the Invention

The invention relates to a microphone device, more particularly to a microphone device adapted to be worn on an ear.

2. Description of the Related Art

Microphone devices adapted for use with portable communications and/or sound reproduction equipment and designed for wearing on the head of a user are known in the art. FIGS. 1 and 2 illustrate a conventional ear-hook microphone device including a pair of rigid ear-hooks 11 adapted for hooking onto the user's ears 10, a connecting piece 12 that interconnects the ear-hooks 11 and that extends behind the user's head, and a sound pickup unit 13 connected to a lower end of one of the ear-hooks 11 and extending to a vicinity of the user's mouth.

Since the shape and size of the head, as well as the shape and size of the ears, vary among different users, when the user of the conventional ear-hook microphone device has a relatively large head, the connecting piece 12 contacts tightly the user's head, and the ear-hooks 11 are hooked tightly on the user's ears 10, thereby resulting in discomfort. On the other hand, when the user of the conventional ear-hook microphone device has a relatively small head or when the back part of the user's head is relatively flat, the conventional ear-hook microphone device cannot be stably positioned on the user's head. In addition, since the ear-hooks 11 do not match the shape and size of the user's ears 10, the user feels uncomfortable when the conventional ear-hook microphone device is used for long periods of time.

### SUMMARY OF THE INVENTION

An object of the present invention is to provide a microphone device that is adapted to be worn on an ear and that can overcome the aforesaid drawbacks of the conventional ear-hook microphone device.

Accordingly, a microphone device of this invention comprises an earpiece unit and a sound pickup unit. The earpiece unit includes a pliable ring part adapted for looping around an ear of a wearer and bendable to conform to the shape of the ear of the wearer. The sound pickup unit includes a boom component that is connected to the earpiece unit and that has a front boom section extending to a vicinity of the mouth of the wearer when the earpiece unit is worn on the ear of the wearer. The sound pickup unit further includes a sound pickup member mounted on the front boom section of the boom component.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional ear-hook microphone device;

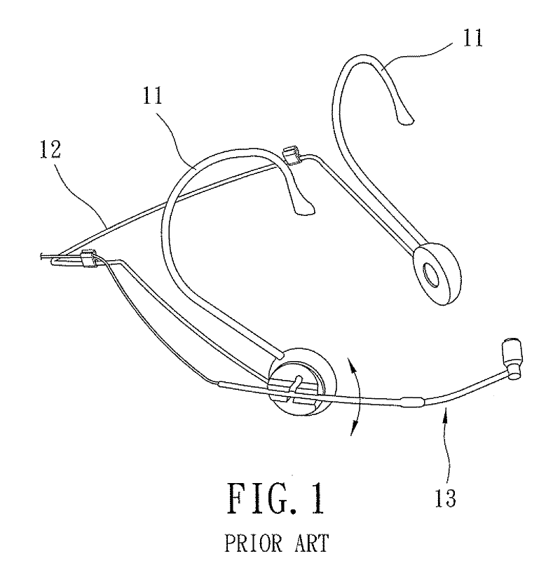

FIG. 2 is a side view of the conventional ear-hook microphone device in a state of use;

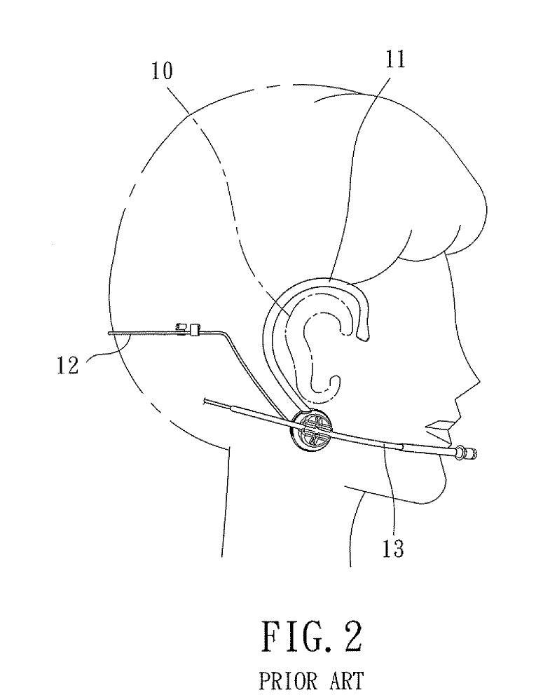

FIG. 3 is a perspective view of the preferred embodiment of a microphone device according to the present invention;

FIG. 4 is a cross-sectional view of an earpiece unit of the preferred embodiment;

FIG. 5 is a perspective view of the preferred embodiment in a state worn on an ear of a wearer; and

FIG. 6 is a view similar to FIG. 5, illustrating the earpiece unit after bending a pliable ring part thereof to secure the microphone device on the ear of the wearer.

### DETAILED DESCRIPTION OF THE PREFERRED EMBODIMENT

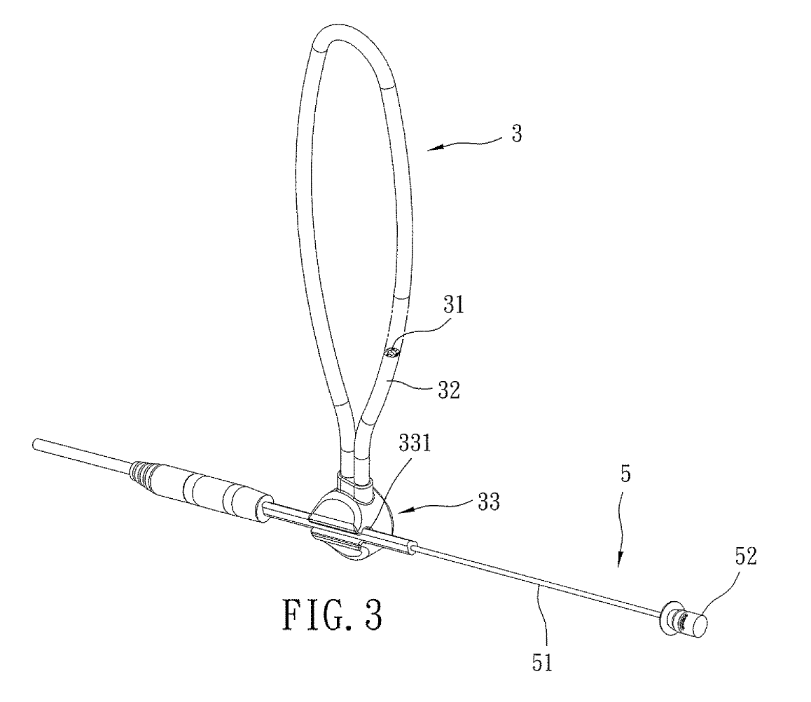

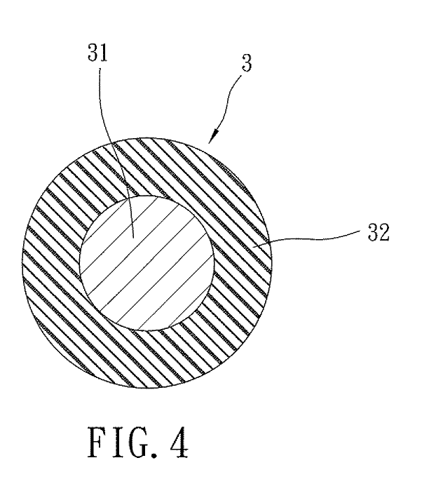

Referring to FIGS. 3, 4 and 5, the preferred embodiment of a microphone device according to the present invention is to be worn on an ear 21 of a wearer 2, and includes an earpiece unit 3 and a sound pickup unit 5.

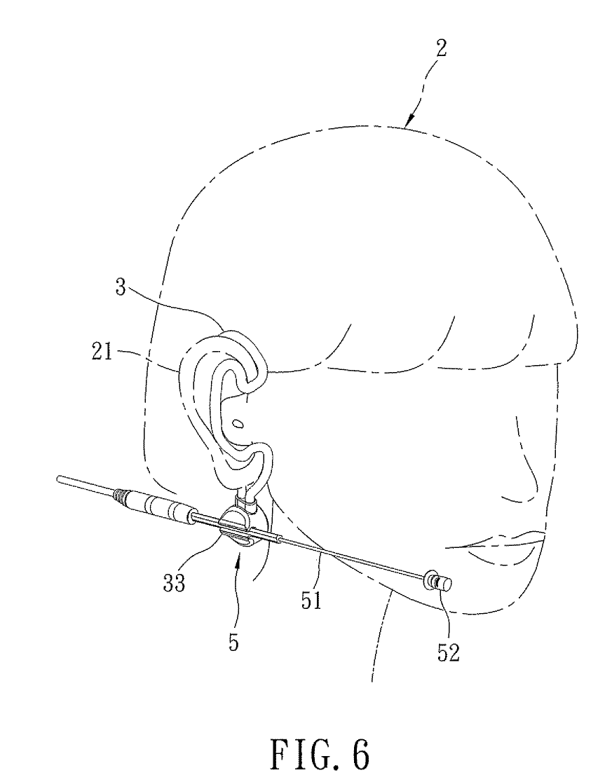

The earpiece unit 3 includes a pliable ring part 31 adapted for looping around the ear 21 of the wearer 2 and bendable to conform to the shape of the ear 21 of the wearer 2 (see FIG. 6). In this embodiment, the ring part 31 is a copper or iron filament, or a metal strip with a serpentine tubular structure. However, the actual material and configuration of the ring part 31 should not be limited to the above examples in practice.

The earpiece unit 3 further includes a flexible sheath 32 that is sleeved on the ring part 31. When the ring part 31 is bent to conform to the shape of the ear 21 of the wearer 2, as shown in FIG. 6, the flexible sheath 32 prevents direct contact between the skin of the wearer 2 and the ring part 31 to thereby enhance comfort when the microphone device is in use.

The sound pickup unit 5 includes a boom component 51 that is connected to the earpiece unit 3 and that has a front boom section extending to a vicinity of the mouth of the wearer 2 when the earpiece unit 3 is worn on the ear 21 of the wearer 2. The sound pickup unit 5 further includes a sound pickup member 52 mounted on the front boom section of the boom component 51. In this embodiment, the front boom section of the boom component 51 is made of a pliable material, e.g., a metal, so as to be bendable and so that the sound pickup member 52 is adjustable relative to the mouth of the wearer 2 to obtain an optimum sound-pickup effect. However, the entire boom component 51 may be made of a rigid material in other embodiments of the invention.

In this embodiment, the ring part 31 has two ends, and the earpiece unit 3 further includes a mounting seat 33 connected to the two ends of the ring part 31, thereby maintaining the ring-shape of the ring part 31. Preferably, the mounting seat 33 has one side formed with a retaining groove 331 that extends in a front-to-rear direction, and the boom component 51 engages the retaining groove 331, thereby connecting the boom component 51 to the mounting seat 33 of the earpiece unit 3.

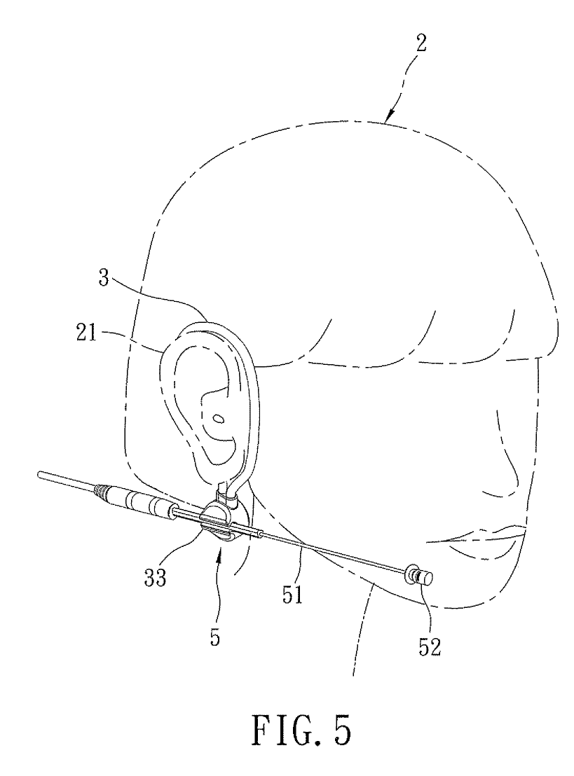

In use, after putting the earpiece unit 3 on the ear 21 of the wearer 2 (see FIG. 5), the ring part 31 is bent to conform to the contour of the ear 21 so as to retain securely the earpiece unit 3 on the ear 21 of the wearer 2, as shown in FIG. 6. Since the flexible sheath 32 is sleeved on the ring part 31, discomfort arising from use of the microphone device of this invention for long periods of time can be minimized.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A microphone device comprising:
an earpiece unit including a pliable ring part adapted for looping around an ear of a wearer and bendable to conform to the shape of the ear of the wearer; and
a sound pickup unit including a boom component that is connected to said earpiece unit and that has a front boom section extending to a vicinity of the mouth of the wearer when said earpiece unit is worn on the ear of the wearer, said sound pickup unit further including a sound pickup member mounted on said front boom section of said boom component.

2. The microphone device as claimed in claim 1, wherein said front boom section of said boom component is pliable so as to be bendable and so that said sound pickup member is adjustable relative to the mouth of the wearer.

3. The microphone device as claimed in claim 1, wherein said earpiece unit further includes a flexible sheath that is sleeved on said ring part.

4. The microphone device as claimed in claim 1, wherein said ring part has two ends, said earpiece unit further including a mounting seat connected to said two ends of said ring part, said boom component being connected to said mounting seat.

5. The microphone device as claimed in claim 4, wherein said mounting seat has one side formed with a retaining groove that extends in a front-to-rear direction, said boom component engaging said retaining groove.
